(19) United States
(12) Patent Application Publication
(10) Pub. No.: US 2014/0038772 A1
(43) Pub. Date: Feb. 6, 2014

(54) Traction Control System For A Hybrid Vehicle

(71) Applicant: Ford Global Technologies, LLC, Dearborn, MI (US)

(72) Inventors: Zhengyu Dai, Canton, MI (US); Michael Glenn Fodor, Dearborn, MI (US)

(73) Assignee: Ford Global Technologies, LLC, Dearborn, MI (US)

(21) Appl. No.: 14/049,700

(22) Filed: Oct. 9, 2013

Related U.S. Application Data
(63) Continuation-in-part of application No. 13/465,407, filed on May 7, 2012.

(51) Int. Cl. B60W 20/00

(52) U.S. Cl. CPC B60W 20/106; Y10S 903/903
USPC 477/3; 903/903; 180/65.28

(57) ABSTRACT

A method for controlling a hybrid vehicle having a traction motor and a torque converter between an engine and a step ratio automatic transmission during a traction control event. The method includes reducing motor torque, and subsequently controlling the torque converter or the step ratio automatic transmission while maintaining engine torque constant during a wheel slip condition of the traction control event to lower driving force transmitted from a driving wheel to a road surface.

### CROSS-REFERENCE TO RELATED APPLICATIONS

This application is a continuation-in-part of U.S. application Ser. No. 13/465,407 filed May 7, 2012, which is incorporated by reference in its entirety.

### TECHNICAL FIELD

The present invention relates to a traction control system for a hybrid vehicle.

### BACKGROUND

A hybrid vehicle powertrain includes an engine and an electric motor. Torque, which is produced by the engine and/or by the motor, may be transferred to the vehicle drive wheels through a transmission. A fraction battery connected to the motor supplies energy to the motor for the motor to produce motor torque. The motor may provide a negative motor torque to the transmission (for example, during regenerative braking) Under such conditions, the motor acts as a generator to the battery.

A hybrid vehicle may have a parallel configuration, a series configuration, or a combination thereof. In a parallel configuration (i.e., a modular hybrid transmission (“MHT”) configuration), the engine is connectable to the motor by a disconnect clutch and the motor is connected to the transmission. The motor may be connected to the transmission via a torque converter having a torque converter clutch. The engine, the disconnect clutch, the motor, the torque converter, and the transmission are connected sequentially in series.

### SUMMARY

Embodiments of the present invention are directed to a controller and a control strategy for a hybrid electric vehicle having an engine, an electric motor, a torque converter with a torque converter clutch, and a transmission. The controller and the control strategy control the motor to lower a driving force transmitted from one or more driving wheels to a road surface during a traction control event. The driving force may be lowered by reducing the torque of the motor in response to a traction control event. Further, if there is any electric motor limitation due to battery state of charge (SOC), the torque converter torque ratio and/or gear ratio can be controlled to support the torque reduction request for the traction event, while maintaining the engine torque at the current level. Such a control strategy can be executed to reduce and/or minimize the engine torque disruption to improve overall vehicle drivability and fuel economy.

Advantageously, the controller and the control strategy can be utilized as a traction control mechanism. Typically, a traction control event occurs when the available traction force is suddenly reduced due to a change of the friction coefficient between the driving wheels and the road, resulting in excessive wheel slip. According to a conventional system, the vehicle quickly reduces the engine torque, and under certain circumstances, the vehicle additionally applies brake torque, to reduce the wheel speed to regain the appropriate traction force. Once the wheel speed slows down to regain sufficient traction force and the tire/road friction returns to normal, the engine torque can be increased to the driver demand level to resume normal driving.

Certain disadvantages may be encountered by quickly reducing engine torque. This quick reduction is usually accomplished by utilizing a spark retard. The spark retard process negatively impacts fuel economy and emission, and may destabilize the combustion process. Alternatively, an air/fuel path can be utilized to reduce the engine torque. However, this process is slower and it also takes a relatively long time to raise the engine torque back up to meet the driver demand after the traction control event concludes.

In contrast to the typical operation occurring as a result of quickly reducing engine torque for traction control, a controller and the control strategy in accordance with embodiments of the present invention maintain the engine torque at a substantially constant torque while using the electrical motor to convert a portion of the torque output from an engine into current to charge a battery in response to a traction control event. This is an option because traction control events are typically short-lived, and therefore, the system can go into a battery charging mode that it would not otherwise be operating in. As a result of substantially maintaining engine torque, a reduction in fuel emissions can be realized. Also, charging the battery by using the motor improves fuel economy. Further, the operation of the controller and the control strategy may reduce driveline disturbances during the traction control event. For instance, better quality torque control is achieved during the traction control event by virtue of the faster response characteristics of the electric machine, thereby improving performance while entering and exiting a traction control event, and during the traction control event.

In at least one embodiment, brake torque applied as the result of fraction control can also come from regenerative braking Further, the controller and the control strategy of embodiments of the present invention can be used in addition to conventional engine and/or braking systems for traction control.

In one embodiment, a method for controlling a hybrid vehicle having a traction motor and a torque converter between an engine and a step ratio automatic transmission during a traction control event is disclosed. The method includes reducing motor torque, and subsequently controlling the torque converter or the step ratio automatic transmission while maintaining engine torque constant during a wheel slip condition of the traction control event to lower driving force transmitted from a driving wheel to a road surface. The controlling step may be initiated upon receiving a signal that the motor has reached a motor torque reduction limit. The motor torque reduction limit may be the battery state of charge (SOC) top limit. The motor torque reduction limit may be battery charging availability diminishment. The controlling step may include controlling the torque converter. The controlling step may include controlling the torque ratio of the torque converter by modulating the torque converter to produce a variable magnitude of slip. The controlling step may include controlling the step ratio automatic transmission. The controlling step includes controlling the gear ratio of the step ratio automatic transmission.

In another embodiment, a system for controlling a hybrid electric vehicle having a traction motor and a torque converter between an engine and a transmission is disclosed. The system includes a controller configured to enter a traction control event, and lower a driving force transmitted from a driving wheel to a road surface by reducing traction motor torque and subsequently controlling the torque converter or the transmission before reducing engine torque during a wheel slip condition of the traction control event. The controller may be further configured to initiate the controlling step upon receiving a signal that the motor has reached a motor torque reduction limit. The motor torque reduction limit may be the battery state of charge (SOC) top limit. The motor torque reduction limit may be battery charging availability diminishment. The controller may be further configured to control the torque converter during the traction control event. The controller may be further configured to control the transmission during the traction control event.

In yet another embodiment, a hybrid electric vehicle including an engine, an electric traction motor selectively coupled to the engine by a clutch, a torque converter, a transmission, and a controller is disclosed. The controller is configured to reduce motor torque and subsequently controlling the transmission or the torque converter while maintaining engine torque constant during a wheel slip condition of a fraction control event. The controller may be further configured to initiate the controlling step upon receiving a signal that the motor has reached a motor torque reduction limit. The motor torque reduction limit may be a battery state of charge (SOC) top limit. The motor torque reduction limit may be a battery charging availability diminishment. The controller may be further configured to control the torque converter during the traction control event. The controller may be further configured to control the transmission during the traction control event.

Additional objects, features, and advantages of embodiments of the present invention will become more readily apparent from the following detailed description when taken in conjunction with the drawings, wherein like reference numerals refer to corresponding parts.

### BRIEF DESCRIPTION OF THE DRAWINGS

FIG. 1 illustrates a block diagram of an exemplary hybrid vehicle powertrain in accordance with an embodiment of the present invention; and

FIG. 2 illustrates a flowchart describing operation of a control strategy for controlling the motor to lower a driving force transmitted for the driving wheels to a road surface with an embodiment of the present invention.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

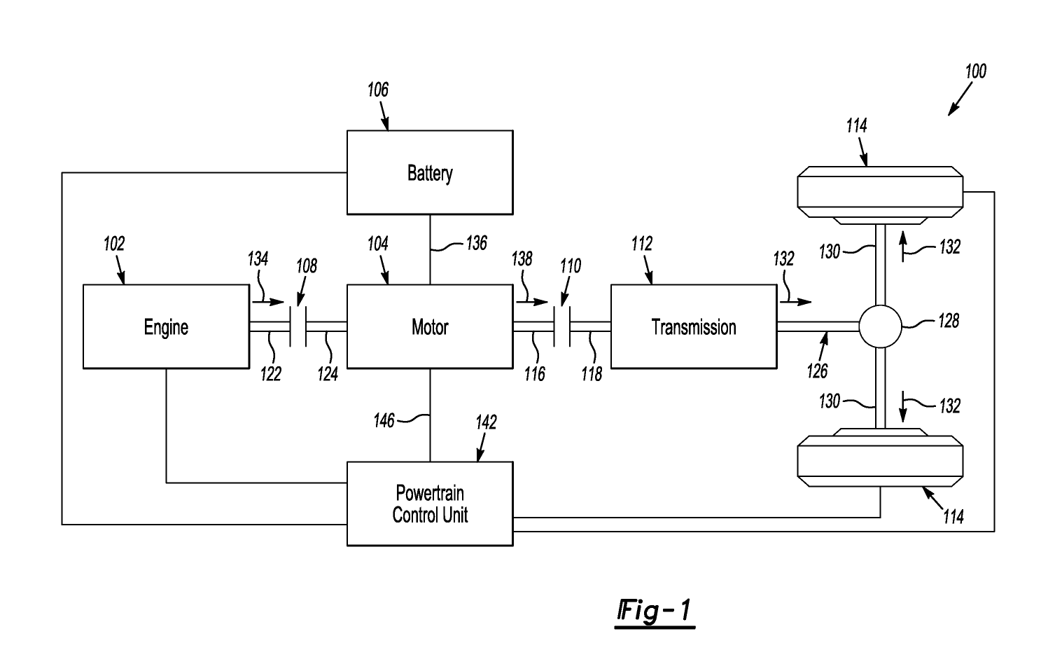

Referring now to FIG. 1, a block diagram of an exemplary powertrain system 100 for a hybrid electric vehicle in accordance with one or more embodiments is shown. Powertrain system 100 includes an engine 102, an electric machine such as an electric motor and generator 104 (otherwise referred to as a “motor”), a traction battery 106, a disconnect clutch 108, a torque converter 110, and a multiple-ratio automatic transmission 112.

Engine 102 and motor 104 are drive sources for the vehicle. Engine 102 is connectable to motor 104 through a disconnect clutch 108 whereby engine 102 and motor 104 are connected in series. Motor 104 is connected to torque converter 110. Torque converter 110 is connected to engine 102 via motor 104 when engine 102 is connected to motor 104 via disconnect clutch 108. Transmission 112 is connected to the drive wheels 114 of the vehicle. The driving force applied from engine 102 and/or motor 104 is transmitted through torque converter 110 and transmission 112 to drive wheels 114 thereby propelling the vehicle.

Torque converter 110 includes an impeller rotor fixed to output shaft 116 of motor 104 and a turbine rotor fixed to the input shaft 118 of transmission 112. The turbine of torque converter 110 can be driven hydro-dynamically by the impeller of torque converter 110. Thus, torque converter 110 may provide a “hydraulic coupling” between output shaft 116 of motor 104 and the input shaft 118 of transmission 112.

Torque converter 110 further includes a torque converter clutch (e.g., a bypass clutch). The torque converter clutch is controllable across a range between an engaged position (e.g., a lock-up position, an applied position, etc.) and a disengaged position (e.g. an unlocked position, etc.). In the engaged position, the converter clutch mechanically connects the impeller and the turbine of torque converter 110 thereby substantially discounting the hydraulic coupling between these components. In the disengaged position, the converter clutch permits the hydraulic coupling between the impeller and the turbine of torque converter 110.

When the torque converter clutch is disengaged, the hydraulic coupling between the impeller and the turbine of torque converter 110 absorbs and attenuates unacceptable vibrations and other disturbances in the powertrain. The source of such disturbances includes the engine torque applied from engine 102 for propelling the vehicle. However, fuel economy of the vehicle is reduced when the converter clutch is disengaged. Thus, it is desired that the converter clutch be engaged when possible.

The torque converter clutch may be controlled through operation of a clutch valve. In response to a control signal, clutch valve pressurizes and vents the converter clutch to engage and disengage. The operation of torque converter 110 can be controlled such that converter clutch is neither fully engaged nor fully disengaged and instead is modulated to produce a variable magnitude of slip in torque converter 110. The slip of torque converter 110 corresponds to the difference in the speeds of the impeller and the turbine of torque converter 110. The slip of torque converter 110 approaches zero as converter clutch 110 approaches the fully engaged position. Conversely, the magnitude of the slip of torque converter 110 becomes larger as the converter clutch moves toward the disengaged position.

When operated to produce a variable magnitude of slip, torque converter 110 can be used to absorb vibrations (for example, when gear ratio changes are being made, when the driver releases pressure from the accelerator pedal, etc.) by increasing the slip, thus causing a greater portion of the engine torque to be passed from the impeller to the turbine of torque converter 110 through hydro-dynamic action. When chance of objectionable vibration and disturbance is absent, the converter clutch can be more fully engaged so that fuel economy is enhanced. However, again, as noted above, it is desired that the converter clutch be engaged when possible as the fuel economy of the vehicle is increased when the converter clutch is engaged.

As indicated above, engine 102 is connectable to motor 104 through disconnect clutch 108. In particular, engine 102 has an engine shaft 122 connectable to an input shaft 124 of motor 104 through disconnect clutch 108. As further indicated above, output shaft 116 of motor 104 is connected to the impeller of torque converter 110. The turbine of torque converter 110 is connected to the input shaft of transmission 112.

Transmission 112 includes multiple gear ratios. Transmission 112 includes an output shaft 126 that is connected to a differential 128. Drive wheels 114 are connected to differential 128 through respective axles 130. With this arrangement, transmission 112 transmits a powertrain output torque 132 to drive wheels 114.

Engine 102 is a primary source of power for powertrain system 100. Engine 102 is an internal combustion engine such as a gasoline, diesel, or natural gas powered engine. Engine 102 generates an engine torque 134 that is supplied to motor 104 when engine 102 and motor 104 are connected via disconnect clutch 108. To drive the vehicle with engine 102, at least a portion of engine torque 134 passes from engine 102 through disconnect clutch 108 to motor 104 and then from motor 104 through torque converter 110 to transmission 112.

Traction battery 106 is a secondary source of power for powertrain system 100. Motor 104 is linked to battery 106 through wiring 136. Depending on the particular operating mode of the vehicle, motor 104 either converts electric energy stored in battery 106 into a motor torque 138 or sends power to battery 106 through wiring 136. To drive the vehicle with motor 104, motor torque 138 is also sent through torque converter 110 to transmission 112. When generating electrical power for storage in battery 106, motor 104 obtains power either from engine 102 in a driving mode or from the inertia in the vehicle as motor 104 acts as a brake in what is referred to as a regenerative braking mode.

As described, engine 102, disconnect clutch 108, motor 104, torque converter 110, and transmission 112 are connectable sequentially in series as illustrated in FIG. 1. As such, powertrain system 100 represents a parallel or modular hybrid transmission (“MHT”) configuration in which engine 102 is connected to motor 104 by disconnect clutch 108 with motor 104 being connected to transmission 112 through torque converter 110.

Depending on whether disconnect clutch 108 is engaged or disengaged determines which input torques 134 and 138 are transferred to transmission 112. For example, if disconnect clutch 108 is disengaged, then only motor torque 138 is supplied to transmission 112. If disconnect clutch is engaged, then both engine torque 134 and motor torque 138 are supplied to transmission 112. Of course, if only engine torque 134 is desired for transmission 112, disconnect clutch 108 is engaged, but motor 104 is not energized such that engine torque 134 is only supplied to transmission 112.

Transmission 112 includes planetary gear sets (not shown) that are selectively placed in different gear ratios by selective engagement of friction elements (not shown) in order to establish the desired multiple drive ratios. The friction elements are controllable through a shift schedule that connects and disconnects certain elements of the planetary gear sets to control the ratio between the transmission output and the transmission input. Transmission 112 is automatically shifted from one ratio to another based on the needs of the vehicle. Transmission 112 then provides powertrain output torque 132 to output shaft 126 which ultimately drives drive wheels 114. The kinetic details of transmission 112 can be established by a wide range of transmission arrangements. Transmission 112 is an example of a transmission arrangement for use with embodiments of the present invention. Any multiple ratio transmission that accepts input torque(s) from an engine and/or a motor and then provides torque to an output shaft at the different ratios is acceptable for use with embodiments of the present invention.

Powertrain system 100 further includes a powertrain control unit 142. Control unit 142 constitutes a vehicle system controller. Based on repositioning an accelerator pedal, the driver of the vehicle provides a total drive command when the driver wants to propel the vehicle. The more the driver depresses pedal, the more drive command is requested. Conversely, the less the driver depresses pedal, the less drive command is requested. When the driver releases the pedal, the vehicle begins to coast.

Control unit 142 apportions the total drive command between an engine torque signal (which represents the amount of engine torque 134 to be provided from engine 102 to transmission 112) and a motor torque signal 146 (which represents the amount of motor torque 138 to be provided from motor 104 to transmission 112). In turn, engine 102 generates engine torque 134 and motor generates motor torque 138 for transmission 112 in order to propel the vehicle. Such engine torque 134 and motor torque 138 for propelling the vehicle are “positive” torques. However, both engine 102 and motor 104 may generate “negative” torques for transmission 112 in order to brake the vehicle.

Control unit 142 is further configured to control clutch valve in order to control operation of the torque converter clutch of torque converter 110. Control unit 142 controls the operation of torque converter 110 such that the converter clutch is modulated across a range between the engaged and disengaged positions to produce a variable magnitude of slip in torque converter 110. Again, the slip of torque converter 110 corresponds to the difference between the input rotational speed and the output rotational speed of torque converter 110. The output rotational speed approaches the input rotational speed as the converter clutch approaches the engaged position such that the slip is zero when the converter clutch is in the fully engaged position. Conversely, the output rotational speed lags the input rotational speed as the converter clutch approaches the disengaged position such that the magnitude of the slip becomes larger. A rotation sensor is configured to sense the slip of torque converter 110 and provide information indicative of the slip to control unit 142.

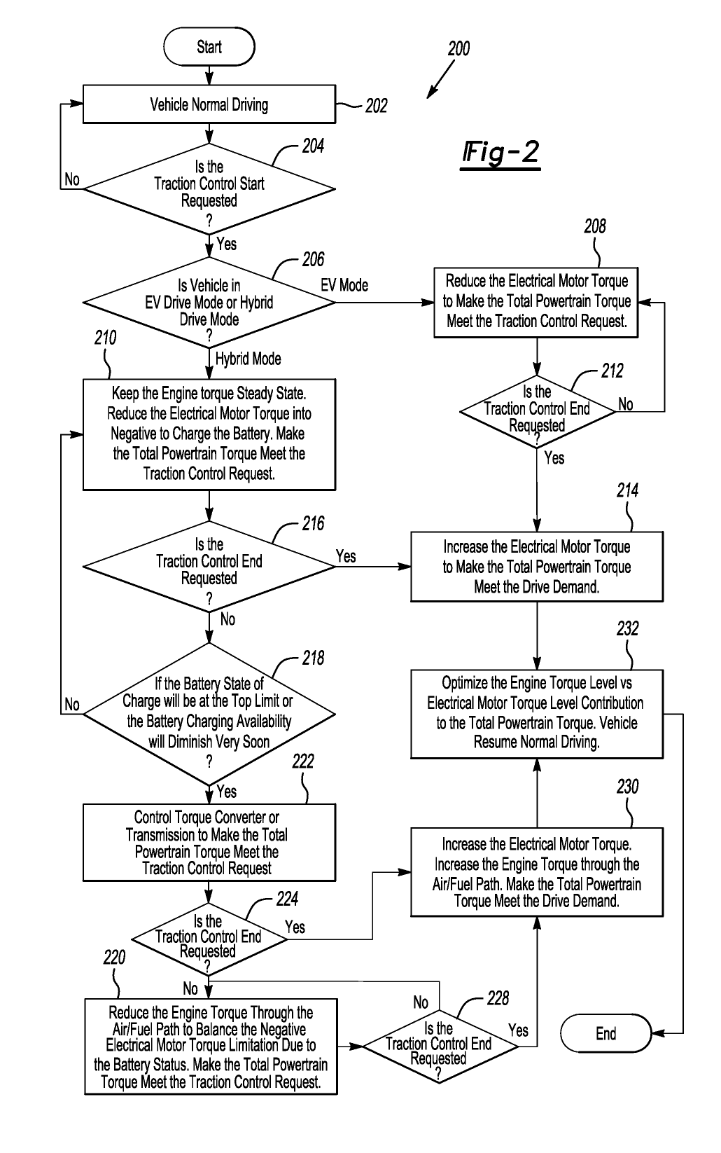

Referring now to FIG. 2, with continual reference to FIG. 1, a flowchart 200 describing operation of a control strategy for traction control in accordance with an embodiment of the present invention is shown.

In block 202, the vehicle is operating in a normal driving mode. In decision block 204, the controller queries whether or not a traction control start has been requested. The traction control event can be detected by sensing an acceleration slip of one or more driving wheels above a certain value. The controller may recognize a wheel slip condition in one or more of the driving wheels. The traction control event may also be signaled by another module or software process on board the vehicle. If a traction control start is requested, then the control strategy proceeds to decision block 206. If a traction control start is not requested, then the control strategy loops back to block 202.

In decision block 206, the controller queries whether the powertrain system is in hybrid mode or EV mode. If the powertrain system is in EV mode, the control strategy proceeds to block 208. If the powertrain system is in hybrid mode, the control strategy proceeds to block 210.

In block 208, the electrical motor torque is reduced to make the total powertrain torque meet the traction control request. The traction control request is a request for reduced torque so that the wheel speed is reduced to eliminate the wheel slip condition and may initiate from another control module or software process on the vehicle.

In decision block 212, the controller queries whether or not a traction control end has been requested. The end of the traction control event occurs when the wheel speed has been reduced a sufficient amount to eliminate the wheel slip condition. If the traction control has ended, then the control strategy proceeds to block 208. If the traction control has not ended, then the control strategy loops back to block 214, and the reduction of the electrical motor torque continues until the traction control event ends.

In block 210, the engine torque is kept at substantially constant torque while the electrical motor torque is reduced to make the total powertrain torque meet the traction control request. The reduction in electrical motor torque can be carried out by applying a negative torque to the electrical motor. During such mode of operation, the electrical motor acts as a generator that converts a portion of the torque output by the engine into current stored by the battery. After block 210, the control strategy proceeds to decision block 216.

In decision block 216, the controller queries whether or not a traction control end has been requested. The end of the traction control event occurs when the wheel speed has been reduced a sufficient amount to eliminate the wheel slip condition. If the traction control has ended, then the control strategy proceeds to block 214. If the traction control has not ended, then the control strategy proceeds to decision block 218.

In decision block 218, the controller queries whether the battery state of charge is at a top limit or the battery charging availability is diminishing in a relatively short time period. If either of these conditions is present, then the control strategy proceeds to block 220. If neither condition is present, then the control strategy loops back to block 210.

In block 222, the torque ratio or gear ratio of the torque converter is controlled to make the total the total powertrain torque meet the traction control request. While performing this control step, the engine torque is kept at steady state and the motor torque is maintained. This control strategy reduces and/or minimizes engine torque disruption to improve overall vehicle drivability and fuel economy.

In decision block 224, the controller queries whether or not a traction control end has been requested. The end of the traction control event occurs when the wheel speed has been reduced a sufficient amount to eliminate the wheel slip condition. If the traction control has ended, then the control strategy proceeds to block 230. If the traction control event has not ended, then the control strategy proceeds to block 226.

In block 226, the engine torque is reduced through the air/fuel path to balance the negative electrical motor torque limitation due to the battery status discussed above. The use of this additional engine torque reduction mechanism allows the total powertrain torque to meet the traction control request. The engine torque may be set lower based on a negative torque limitation of the motor due to battery charging limits. After block 226, the control strategy proceeds to decision block 228.

In decision block 228, the controller queries whether or not a fraction control end has been requested. The end of the traction control event occurs when the wheel speed has been reduced a sufficient amount to eliminate the wheel slip condition. If the traction control has ended, then the control strategy proceeds to block 230. If the traction control has not ended, then the control strategy proceeds to block 226.

In block 230, the control strategy recognizes that the traction control event has ended. As such, the electrical motor torque is increased and/or the engine torque is increased through the air/fuel path. These increases are done to make the total powertrain torque meet the drive demand under normal operating conditions.

As shown in block 232, the contribution of the engine torque level and the motor torque level is optimized based on the total powertrain torque required.

Moving back to block 214, the electrical motor torque is increased to make the total powertrain torque meet the drive demand. This increase is done to make the total powertrain torque meet the drive demand under normal operating conditions. After block 214, the control strategy proceeds to block 232.

In one or more embodiments, a traction control module or software process may transmit a torque request signal to a module or software process responsible for adjusting the motor and/or engine torque.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A method for controlling a hybrid vehicle having a traction motor and a torque converter between an engine and a step ratio automatic transmission during a traction control event, comprising:
reducing motor torque, and subsequently controlling the torque converter or the step ratio automatic transmission while maintaining engine torque constant during a wheel slip condition of the traction control event to lower driving force transmitted from a driving wheel to a road surface.

2. The method of claim 1, wherein the controlling step is initiated upon receiving a signal that the motor has reached a motor torque reduction limit.

3. The method of claim 2, wherein the motor torque reduction limit is the battery state of charge (SOC) top limit.

4. The method of claim 2, wherein the motor torque reduction limit is battery charging availability diminishment.

5. The method of claim 1, wherein the controlling step includes controlling the torque converter.

6. The method of claim 5, wherein the controlling step includes controlling the torque ratio of the torque converter by modulating the torque converter to produce a variable magnitude of slip.

7. The method of claim 1, wherein the controlling step includes controlling the step ratio automatic transmission.

8. The method of claim 7, wherein the controlling step includes controlling the gear ratio of the step ratio automatic transmission.

9. A system for controlling a hybrid electric vehicle having a traction motor and a torque converter between an engine and a transmission, comprising:
a controller configured to enter a traction control event, and lower a driving force transmitted from a driving wheel to a road surface by reducing traction motor torque and subsequently controlling the torque converter or the transmission before reducing engine torque during a wheel slip condition of the traction control event.

10. The system of claim 9 wherein:
the controller is further configured to initiate the controlling step upon receiving a signal that the motor has reached a motor torque reduction limit.

11. The system of claim 9 wherein:
the motor torque reduction limit is the battery state of charge (SOC) top limit.

12. The system of claim 9 wherein:
the motor torque reduction limit is battery charging availability diminishment.

13. The system of claim 9 wherein:
the controller is further configured to control the torque converter during the fraction control event.

14. The system of claim 9 wherein:
the controller is further configured to control the transmission during the traction control event.

15. A hybrid electric vehicle comprising:
an engine;
an electric traction motor selectively coupled to the engine by a clutch;
a torque converter;
a transmission; and
a controller configured to reduce motor torque and subsequently control the transmission or the torque converter while maintaining engine torque constant during a wheel slip condition of a traction control event to lower driving force transmitted from a driving wheel to a road surface.

16. The vehicle of claim 15 wherein:
the controller is further configured to initiate the controlling step upon receiving a signal that the motor has reached a motor torque reduction limit.

17. The vehicle of claim 15 wherein:
the motor torque reduction limit is the battery state of charge (SOC) top limit.

18. The vehicle of claim 15 wherein:
the motor torque reduction limit is battery charging availability diminishment.

19. The vehicle of claim 15 wherein:
the controller is further configured to control the torque converter during the traction control event.

20. The vehicle of claim 15 wherein:
the controller is further configured to control the transmission during the traction control event.
